(19) United States
(12) Patent Application Publication
(10) Pub. No.: US 2026/0298791 A1
(43) Pub. Date: Oct. 1, 2026

(54) METROLOGY PLATFORM METHODS AND SYSTEMS FOR PARTICULATE ASSESSMENT

(71) Applicant: Taiwan Semiconductor Manufacturing Company, LTD., Hsinchu (TW)

(72) Inventors: Wei-Huai Chiu, Zhunan (TW); Tsung-Chi Yu, Hsinchu (TW); Po-Chun Huang, Hsinchu (TW); Han-Lung Chang, Kaohsiung (TW); Chun-Lin Chang, Zhubei (TW)

(21) Appl. No.: 19/096,986

(22) Filed: Apr. 1, 2025

(51) Int. Cl. G01N 15/0227; G01N 15/14; G01N 15/1433

(52) U.S. Cl. CPC G01N 15/0227; G01N 15/1433; G01N 2015/1486

(57) ABSTRACT

A metrology platform method and system for particulate assessment, such as particulate location and size measurement on a particulate absorber, associated with a laser scanner source used for semiconductor manufacturing. According to an example embodiment, a camera and light arrangement is mounted to a motor driven arm that holds the camera and light at a moveable measurement distance from a particulate absorber attached to a platform for inspection. The camera captures high-resolution images with high contrast at one or more locations which are further processed by one or more image processing systems, controllers or modules to locate and count the number of particulates within the captured image of the particulate absorber. In addition, other image processing may be completed to determine other characteristics of the located particulates, including but not limited to, particulate size, particulate shape, particulate material, etc.

### BACKGROUND

The following relates to optical inspection systems and methods used for semiconductor fabrication laser sources, and the like. Specifically, the following relates to the inspection of a test surface of a component for particulates, other debris or contaminates after a cleaning cycle has been performed on a device, such as a laser scanner source used for semiconductor manufacturing.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a schematical view of a metrology platform system for particulate assessment, such as particulate measurement and counting, according to an example embodiment of this disclosure, the system including an optical inspection system including a single light and camera robotic arm arrangement (Embodiment 1A), and, alternatively, the system including an optical inspection system including a multiple light and camera robotic arm/fixed mount arrangement (Embodiment 1B).

FIG. 1B is a detailed view of a light source including an integrated coaxial light source and a ring light source according to an example embodiment of this disclosure.

FIG. 1C is another detailed view of a light source including an integrated coaxial light source and a ring light source as shown in FIG. 1B, with an additional independent other environmental light source and according to an example embodiment of this disclosure.

FIG. 1D is a schematical representation of three positions, within a xz plane, of the light and camera relative to a particulate absorber inspection surface according to an example embodiment of this disclosure, the light and camera positions including a 1^{st} position CAM/LIGHTPos1 to capture a centered top view image of the particulate absorber being inspected, a 2^{nd} position CAM/LIGHTPos2 within xzQuadrant1 to capture a first profile image of the particulate absorber being inspected, and a 3rd position CAM/LIGHTPos3 within xzQuadrant 2 to capture a second profile image of the particulate absorber being inspected.

FIG. 1E is a schematical representation of three positions, within a yz plane, of the light and camera relative to a particulate absorber inspection surface according to an example embodiment of this disclosure, the light and camera positions including a 1^{st} position CAM/LIGHTPos1 to capture a centered top view image of the particulate absorber being inspected, a 2^{nd} position CAM/LIGHTPos2 within yzQuadrant1 to capture a first profile image of the particulate absorber being inspected, and a 3rd position CAM/LIGHTPos3 within yzQuadrant 2 to capture a second profile image of the particulate absorber being inspected.

FIG. 2A is a flow chart of an optical inspection method for particulate assessment, such as particulate measurement and counting, including the determination of a particulate count associated with a particulate absorber according to an example embodiment (Embodiment 2) of this disclosure, the method including the acquisition of a centered top view image of the absorber inspection surface and one or more profile images of the absorber inspection surface, and performing a count of the absorber particulates on the absorber inspection surface.

FIG. 2B is a detailed view of two example particulates, P1 and P2, detected within a gray scale image GScaleImage generated according to the method of FIG. 2A.

FIG. 2C is a detailed plot of gray value pixel intensity values vs pixel location for the example particulates, P1 and P2, shown in FIG. 2B.

FIG. 2D is another detailed view of a complete image of a captured center top view image of a particulate absorber, after converted to a gray scale image GScaleImage, showing a plurality of particulates P (not all Ps labeled) detected within defined scan regions of interest (ROI) in the gray scale image generated according to the method of FIG. 2A.

FIGS. 2E, 2F and 2G is another illustration of the absorber particulate image processing steps to count particulates on a captured image of the absorber inspection surface shown in FIG. 2A, where FIG. 2E shows an original captured image of the absorber inspection surface used to measure a detected particulate size, based on the particulate's location determination from a gray scale image scan process to locate pixel intensity inflictions, as shown in FIG. 2F, within a threshold pixel value range delatPixel, as shown in FIG. 2G.

FIGS. 2H, 2I and 2J is another illustration of the absorber particulate image processing steps to count particulates on a centered top view image of the absorber inspection of the absorber inspection surface according to the method of FIG. 2A, where FIG. 2H shows an original captured image of the absorber inspection surface, FIG. 2I shows a gray scale converted image used to detect and measure particulate locations, and FIG. 2J shows a plurality of particulates counted (1-29), based on a threshold pixel intensity value, within the original captured image at the particulate locations detected within the gray scale image GScaleImage.

FIG. 3 is a flow chart of an optical inspection method of particulate assessment for determining a particulate count associated with a particulate absorber according to an example embodiment (Embodiment 3) of this disclosure, the method including the acquisition of a centered top view image of the absorber inspection surface and one or more profile images of the absorber inspection surface, and using a classifier to perform one or more of a count of the absorber particulates on the absorber inspection surface, particulate size of the absorber particulates on the absorber inspection surface, particulate shape of the absorber particulates on the absorber inspection surface particulates and/or mechanical property of the absorber particulates on the absorber inspection surface particulates.

FIG. 4 is a block diagram of a metrology platform system for particulate assessment including particulate size measurement and particulate counting according to an example embodiment of this disclosure.

### DETAILED DESCRIPTION

The following disclosure provides many different embodiments, or examples, for implementing different features of the described subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Numerical values in the specification and claims of this application should be understood to include numerical values which are the same when reduced to the same number of significant figures and numerical values which differ from the stated value by less than the experimental error of conventional measurement technique of the type described in the present application to determine the value. All ranges disclosed herein are inclusive of the recited endpoint.

The term “about” can be used to include any numerical value that can vary without changing the basic function of that value. When used with a range, “about” also discloses the range defined by the absolute values of the two endpoints, e.g., “about 2 to about 4” also discloses the range “from 2 to 4.” The term “about” may refer to plus or minus 10% of the indicated number.

The term “substrate” herein generally refers to the bulk substrate on which various layers and device structures are formed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The term “orthogonal axis,” as used herein, refers to an axis substantially at 90 degrees relative to a longitudinal axis extending along an inspection surface of a structure.

As used herein, the term “optic” or “optical” is meant to be broadly construed to include, and not necessarily be limited to, one or more components which reflect and/or transmit and/or operate on incident light, and includes, but is not limited to, one or more lenses, windows, filters, wedges, prisms, prisms, gratings, transmission fibers, etalons, diffusers, homogenizers, detectors and other instrument components, apertures, axicons and mirrors including multi-layer mirrors, near-normal incidence mirrors, grazing incidence mirrors, specular reflectors, diffuse reflectors and combinations thereof. Moreover, unless otherwise specified, the term “optic,” as used herein, is not meant to be limited to components which operate solely within one or more specific wavelength range(s) such as at the EUV output light wavelength, the irradiation laser wavelength, a wavelength suitable for metrology or any other specific wavelength.

The term “profile image” as used herein refers to an image of a target object, e.g., absorber articulate, from a side perspective of the target object. In other words, an image of a target object which is not directly overhead or not a bird's eye view of the target object.

The term “controller” and “module” as used herein are interchangeable and refer to a software and/or hardware component of a system that executes software and/or operates in a manner to execute a process including, but not limited to the execution of an algorithm, e.g., image processing algorithm to perform one or more of determining particulate counts, particulate size, particulate shape, particulate material, particulate classification, etc.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

Technological advances in semiconductor manufacturing and design have produced successive generations of semiconductor devices with ever smaller and more complex circuits and structures. In the course of their evolution, functional density, namely the number of interconnected devices per chip area, has generally increased while geometric size (the smallest line, structure or component that may be created during fabrication) has decreased. This scaling-down process generally increases semiconductor processing efficiency, thus lowering overall production costs. However, these benefits come with increased processing complexity in both their design and manufacture.

In order to continually achieve smaller geometric sizes, ever higher-resolution lithography processes are necessary. One growing lithography technique is extreme ultraviolet (EUV) lithography. EUV employs scanners using light in the EUV spectrum of electromagnetic radiation, including wavelengths from about one nanometer (nm) to about one hundred nm. Many EUV scanners still utilize projection printing, similar to various earlier optical scanners, except EUV scanners accomplish it with reflective rather than refractive optics, that is, with mirrors instead of lenses.

In particular, EUV lithography employs a laser-produced plasma (LPP), which emits EUV light. By focusing a high-power laser beam, as generated by a carbon dioxide (CO2) laser and the like, onto small fuel droplet targets in order to transition it into a highly-ionized LPP. This plasma emits EUV light with a peak maximum emission of about 13.5 nm or smaller. The EUV light is then collected by a collector and reflected by optics towards a lithography exposure object, such as a semiconductor wafer.

A lithography system is essentially a projection system. Light is projected through a blueprint of the pattern that will be printed, and is known as a ‘mask’ or ‘reticle.’ The blueprint is four times larger than the intended pattern on the chip. With the pattern encoded in the light, the system's optics shrink and focus the pattern onto a photosensitive silicon wafer. After the pattern is printed, the system moves the wafer slightly and makes another copy on the wafer. This process is repeated until the wafer is covered in patterns, completing one layer of the eventual semiconductor device. To make an entire microchip, this process will be repeated one hundred times or more, laying patterns on top of patterns. The size of the features to be printed varies depending on the layer, which means that different types of lithography systems are used for different layers, from the latest-generation EUV systems for the smallest features to older deep ultraviolet (DUV) systems for the largest.

EUV system scanners require maintenance, such as cleaning, to provide their intended purpose for high quality semiconductor fabrication processing. One area of the EUV scanners that requires cleaning is the power amplifier section which a seed laser is transferred by a gain medium within a resonator. The power amplifier is periodically required to be cleaned and subsequently purged with a gas, for example N₂, prior to normal use or further cleaning processes.

Monitoring systems can be used to monitor various conditions to determine whether a cleaning process, such as online cleaning process or an offline cleaning process should be initiated to clean the power amplifiers of the laser generator of the excitation laser source apparatus. In some systems, the monitoring system monitors an amount of CO in the gas circulation system of the power amplifiers using a CO sensor or the like. In such systems, if an established threshold of CO is detected, an alert may be issued by the monitoring system and a cleaning process may be initiated. In some systems the monitoring system measures a thickness of a SiO₂ layer built up at one or more places on the surface of the Au layer of the catalyst. If an established threshold of SiO₂ is detected, an alert may be issued by the monitoring system and a cleaning process may be initiated. In some systems, the monitoring system monitors a power level of the CO₂ laser during operation. In such systems, if a power level of the CO₂ laser falls below an established limit, an alert may be issued by the monitoring system and a cleaning process may be initiated.

Several mirrors are used to provide a laser path in the power amplifier, and the power amplifier operating environment is a vacuum. Therefore, after maintenance of the power amplifier is performed in an atmospheric environment, it is necessary to use a gas, such as N₂ gas, to purge the power amplifier and ensure the removal of particulates produced during maintenance. This process, called the clean cycle, involves purging and removing particulates to protect the mirror surfaces during normal exposure operation, and is performed with the mirrors removed from the system to prevent contaminating the mirror. A particulate absorber is installed in the same position as the mirror to prevent contaminating the mirror surfaces, whereby the particulate absorber captures particulates on the absorber, ensuring that no particulates remain when the mirrors are reinstalled. To ensure that the test environment, i.e., purged power amplifier environment, is sufficiently clean for subsequent operations, the particulate absorber is removed and inspected to determine the number and size of particulates adhered to the particulate adhesion surface of the absorber. Currently, the inspection of the particulate absorber is performed by a service technician or other personnel, where a visual inspection is completed with the appropriate optical equipment to judge the condition of the particulate absorber. In other words, a subjective evaluation is completed to determine the whether or not the laser power amplifier is sufficiently clean or out-of-specification (OOS) for subsequent operations.

A scanner is required to perform additional cleaning cycle due to an OOS judgement indicating that the particulate absorber has remaining particulates, which can require several hours to complete, thereby delaying the use of the scanner for normal operation. Because the existing particulate absorber inspection criteria for determining particulate size by subjective visual inspection is not clearly defined, particulate count, shape and/or size is recognized based on the inspector's subjective cognition, which can lead to inconsistent evaluations and undue delays for placing the laser back into service and/or performing subsequent cleaning or maintenance processes. To avoid these unnecessary delays, disclosed herein are metrology platform methods and systems for the objective particulate measurement and counting which do not require visual inspection of the particulate absorber by an engineer, technician or other personnel. According to an example embodiment, the disclosed metrology platform method and system automatically moving a light source and camera to specific position(s), relative to the particulate absorber inspection surface, i.e. the particulate adhesion surface of the absorber, to capture images of the particulate absorber with high contrast for determining particulate counts, particulate size, particulate shape, etc. to improve the quality and consistency of the particulate absorber inspection process, whereby the misjudgment of human eyes is avoided. Furthermore, by capturing images of the particulate absorber at a plurality of predetermined or specific locations of the camera and light for all inspections of the particulate absorber, as well as other particulate absorber inspections for other laser systems, consistency in the evaluation results can be maintained, thereby providing an improved objective particulate absorber evaluation process to minimize delays due to the laser cleaning process.

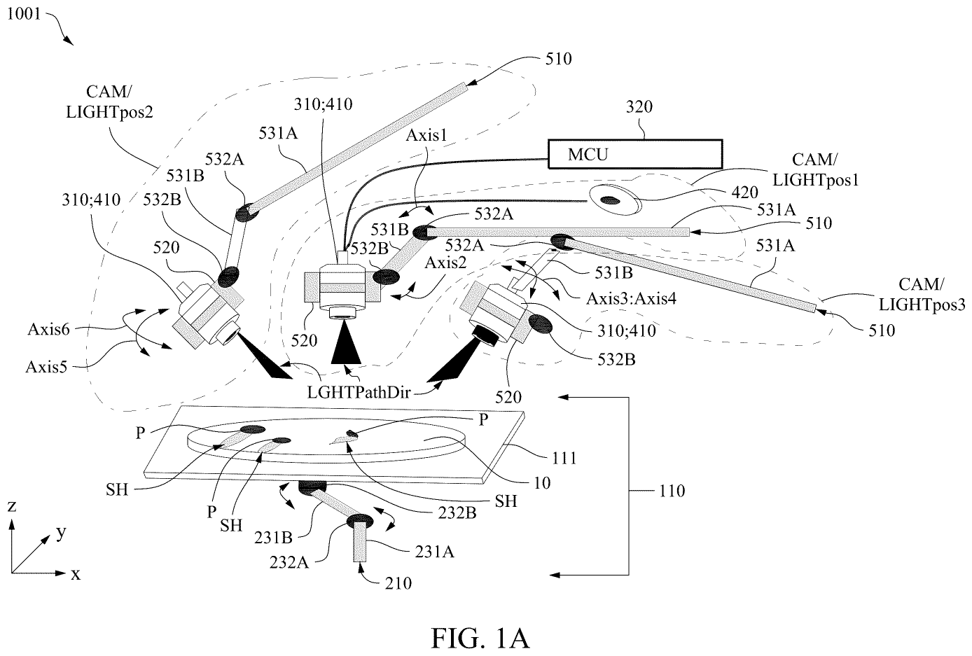

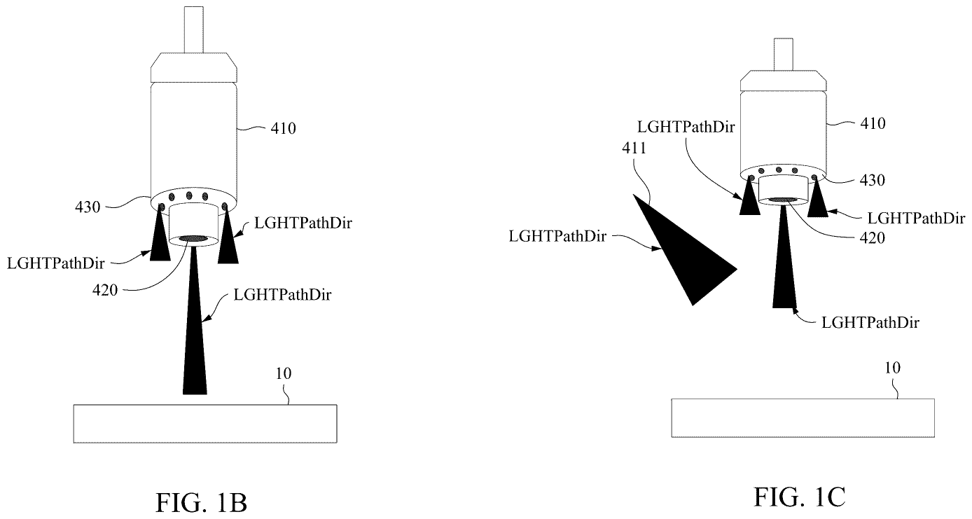

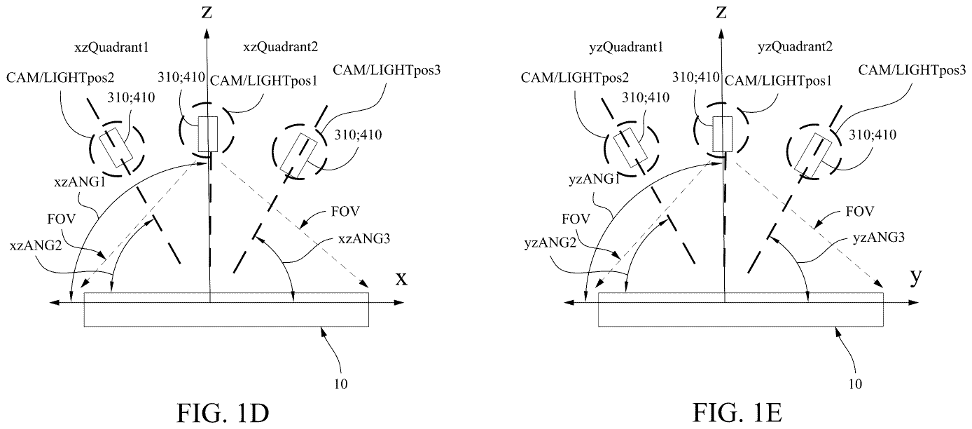

Another advantage and benefit of the disclosed metrology platform methods and systems relates to the shadowing effect of existing image capturing systems used for inspection of particulate absorbers, which can negatively affect the particulate illuminated light color and field brightness. As will be further described with reference to FIG. 1A, existing optical inspection systems can produce shadows SH (see FIG. 1A) on the inspection surface depending on the alignment or orientation of any lights used during an image acquisition process, thereby degrading the contrast and overall quality of the captured images for analysis and providing false counts of a particulate count present on an inspected particulate absorber. According to an example embodiment of the disclosed metrology platform methods and systems, in addition to a centered top view image of the inspection surface of the particulate absorber, one or more profile images of the inspection surface of the particulate absorber are captured to compensate for the shadowing effect of the light. While the centered top view image of the inspection surface of the particulate absorber is captured with the camera and light substantially orthogonal to the inspection surface of the particulate absorber, i.e., directly overhead, the one or more profile images of the inspection surface are captured at an alignment angle substantially nonorthogonal to the inspection surface of the particulate absorber. Furthermore, according to an example embodiment, the disclosed metrology platform method and system includes a particulate absorber defined to include a xz plane extending from the inspection surface, where the inspection surface is aligned along the x axis, and the z axis is orthogonal to the x axis and extends from a center of the particulate absorber to bifurcate the xz plane into a first quadrant and a second quadrant the acquisition of a first profile image within a first quadrant of the xz plane. A first profile image of the inspection surface of the particulate absorber is captured with the camera and light located within the first quadrant of the xz, and a second profile image of the inspection surface of the particulate absorber is captured with the camera and light located within the second quadrant of the xz, thereby obtaining particulate absorber images which collectively minimize the shadowing effect of the lights by providing relatively opposite profile images of the absorber particulates. As will be described with reference to FIG. 1E below, these profile images can also be varied within a yz plane defined as well.

The following discloses a metrology platform method and system for particulate assessment, such as particulate size location and size measurement on a particulate absorber associated with a laser scanner source used for semiconductor manufacturing with certain advantages as disclosed herein. Specifically, according an example embodiment, optical platform methods and systems are disclosed herein that determine particulate size, particulate counts, particulate positions, particulate shapes, and/or particulate material properties on an inspection surface, for example a particulate absorber used for a laser cleaning operation, such as but not limited to, a power amplifier section as previously described. The particulate information determined by the metrology platform methods and systems described herein can be used as a reference for a next step in the evaluation process of the laser.

According to some example embodiments disclosed herein, a camera and light arrangement is mounted to a motor driven arm, for example a robotic arm, which holds the camera and light at a moveable measurement distance from a particulate absorber attached to a platform for inspection. The camera captures high-resolution images with high contrast at one or more locations which are further processed by one or more image processing systems, controllers or modules to locate and count the number of particulates within the captured image of the particulate absorber. In addition, other image processing may be completed to determine other characteristics of the located particulates, including but not limited to, particulate size, particulate shape, particulate material, etc. According to an example embodiment, a classifier is trained, either supervised or unsupervised or a combination thereof, according to appropriate know machine learning (ML) techniques to classify input images of the particulate absorber as belonging to one of a plurality of particulate categories, one of a plurality of particulate size categories, one of a plurality of particulate material categories, etc. Finally, the disclosed metrology platform methods and systems determine can determine a pass or fail condition associated with the inspected particulate absorber based on the determined particulate size, particulate counts, particulate positions, particulate shapes, and/or particulate material properties on an inspection surface, whether determined based on distinct pixel based image processing algorithms or classification processes described herein.

While the disclosed metrology platform methods and systems for particulate assessment are described in the context of optically inspecting a particulate absorber using one or more moveable lights and cameras to 1) capture a centered top view image of the inspection surface of the particulate absorber substantially orthogonal to the inspection surface of the particulate absorber, and/or 2) capture one or more profile images of the inspection surface of the particulate absorber substantially nonorthogonal to the inspection surface of the particulate absorber, and processing the particulate absorber images to determine characteristics of the particulates attached thereto, it is to be understood that the disclosed metrology platform methods and systems are not limited to moveable cameras and lights to capture images and can also include fixed camera and light arrangements to capture these particulate absorber images. Furthermore, while the disclosed metrology platform methods and systems are described in the context of optically inspecting a particulate absorber associated with a laser system power amplifier, where the particulate absorber is removed from the power amplifier and placed on an inspection platform for imaging, the disclosed metrology platform methods and systems are not limited to particulate absorbers used for the inspection of a laser system power amplifier system and can also be used for inspection of other particulate collecting surfaces associated with a lithography laser system or other semiconductor processing tool. Moreover, the disclosed metrology platform methods and systems can be integrated into a laser system whereby the particulate absorber and/or the camera and light arrangement is housed within a chamber of a laser system for monitoring and/or inspection of a particulate absorption surface to provide a cleanliness indication of the chamber.

Nonlimiting features of the disclosed metrology platform methods and systems for particulate measurement and counting include determining optical particulate counts, sizes, shapes and quantify, where a particulate recognition platform includes a particulate absorber serving as a medium to collect particulates in a light path of a laser light path during exposure, the particulate absorber being a relatively flat surface and having a light color which provides a high contrast image of the particulates adhered thereto by a sticky surface attached to the particulate absorber inspection surface. The particulate absorber is mounted to a particulate absorber inspection platform has multidirectional movement, e.g., 3-axis, 4-axis, etc., to position and align the absorber inspection surface to optimally capture an image of the particulate absorber. The disclosed metrology platform methods and systems precisely identify the number, size and shape of the contaminated particulates by varying emitted light angle and shadow of objects over a flat surface by a multidimensional movement, e.g. 2-axis, 3-axis, 4-axis, 6-axis, etc., of a charge-coupled device (CCD) camera with a corresponding white light source attached thereto, which also provides color and contour characteristics of the particulates. According to an example embodiment, a machine learning process/classifier/algorithm is used to process the captured images and categorize, or classify, the images as representative of one of a plurality of particulate characteristic categories or classes to provide a particulate absorber condition judgement standard for a pass or fail determination, or determining of other conditional states of the particulate absorber.

According to some embodiments, the structures disclosed herein include, but are not limited to, the following.

Embodiment 1A (System/Apparatus): A metrology platform system for particulate measurement and counting which includes a single camera and light arrangement mounted to a movable arm where different alignment positions of the camera and light, relative to a particulate absorber mounted to a platform, are used to capture images of the particulate absorber.

Embodiment 1B (System/Apparatus): A metrology platform system for particulate measurement and counting which includes a multiple camera and multiple light arrangement mounted at different alignment positions of the camera and light, relative to a particulate absorber mounted to a platform, are used to capture images of the particulate absorber.

Embodiment 2 (Method): A method of determining a particulate count associated with a particulate absorber which includescapturing a centered top view image of the inspection surface of the particulate absorber substantially orthogonal to the inspection surface of the particulate absorber, and capturing one or more profile images of the inspection surface of the particulate absorber substantially nonorthogonal to the inspection surface of the particulate absorber with the light source and camera oriented at the second orientation.

Embodiment 3 (Method): A method of determining a particulate count associated with a particulate absorber which includescapturing a centered top view image of the inspection surface of the particulate absorber substantially orthogonal to the inspection surface of the particulate absorber, capturing one or more profile images of the inspection surface of the particulate absorber substantially nonorthogonal to the inspection surface of the particulate absorber with the light source and camera oriented at the second orientation; and using an image classifier, classifying the centered top view image, and the one or more profile images to determine one or more of the total number of particulates on the inspection surface of the particulate absorber, the particulate size of particulates on the inspection surface of the particulate absorber and a particulate shape of particulates on the inspection surface of the particulate absorber.

Embodiment 4 (System): A metrology platform system for particulate measurement and counting which includes a single camera and light arrangement mounted to a movable arm where different alignment positions of the camera and light, relative to a particulate absorber mounted to a platform, are used to capture a centered top view image of the inspection surface of the particulate absorber substantially orthogonal to the inspection surface of the particulate absorber, capture one or more profile images of the inspection surface of the particulate absorber substantially nonorthogonal to the inspection surface of the particulate absorber with the light source and camera oriented at the second orientation; and using an image classifier, classifying the centered top view image, and the one or more profile images to determine one or more of the total number of particulates on the inspection surface of the particulate absorber, the particulate size of particulates on the inspection surface of the particulate absorber and a particulate shape of particulates on the inspection surface of the particulate absorber.

With reference to FIGS. 1A-1E, shown are various details and example embodiments (Embodiments 1A and 1B) 1001 of the metrology platform method and system disclosed herein.

FIG. 1A shows a schematical view of a metrology platform system for particulate assessment, such as particulate measurement and counting, according to an example embodiment of this disclosure, the system including an optical inspection system including a single light and camera robotic arm arrangement (Embodiment 1A), and, alternatively, the system including an optical inspection system including a multiple light and camera robotic arm/fixed mount arrangement (Embodiment 1B).

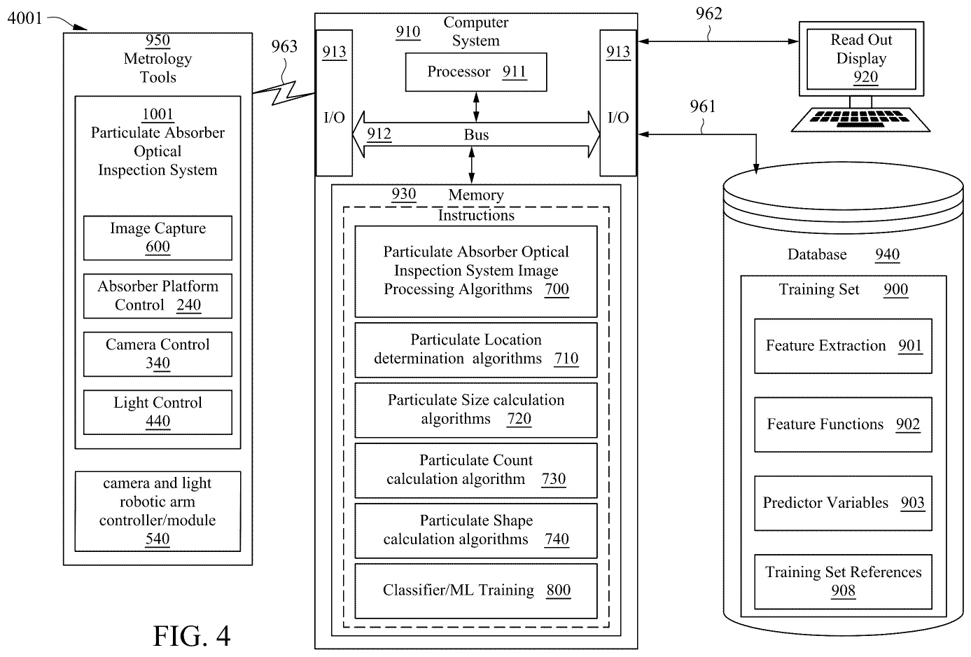

As shown, the metrology platform system 1001 for particulate measurement and counting includes an absorber platform assembly 110 having a absorber platform 111 and absorber platform arm 210 for multidirectional movement of the absorber platform 111 and particulate absorber 10 fixed thereto. To provide multidirectional movement of the absorber platform 111, the absorber platform arm 210 has arm segments 231A and 231B, which are coupled to each other and other segments or a base of the platform arm 110 using moveable/rotatable joints 232A and 232B. An absorber platform arm controller/module 240 (not shown; see FIG. 4) is operatively connected to the absorber platform arm 210 to control movement of the absorber platform arm 210, and particulate absorber 10 attached thereto, relative to a desired position for capturing images of the attached particulate absorber 10 using a camera 310 and light source 410 attached to another moveable arm 510 using a camera/light mount 520. Similar to the absorber platform arm 210, the camera 310 and light source 410 are attached to a camera and light multidirectional arm 510, e.g., robotic arm, having a plurality of arm segments 531A and 531B and moveable/rotatable joints 532A and 532B to provide multidirectional movement (Axis1, Axis2, Axis3, Axis4, Axis5 and Axis6) of the camera 310 and light source 410 to position the camera 310 and light source 410 using a camera and light robotic arm controller/module 540 (not shown; see FIG. 4) to capture images of the particulate absorber 10, including one or more of a centered top view image of the particulate absorber 10 and one or more profile images of the particulate absorber 10 at a camera and light position different from the position of the camera and light source for capturing a centered top view image of the particulate absorber 10. A microcontroller receiver unit (MCU) 320 receives the images captured by the camera 310 and performs one or more of 1) processing the images to perform a particulate count, particulate size, particulate shape, and/or particulate material, and/or 2) communicating the captured images to other image processing modules (not shown) for further processing to perform a particulate count, particulate size, particulate shape, and/or particulate material.

With continued reference to FIG. 1A, the multidirectional arrangement of the camera and light is indicated by CAM/LIGHTpos1, CAM/LIGHTpos2, and CAM/LIGHTpos3, where the centered top view image of the particulate absorber 10 is captured at CAM/LIGHTpos1, a first profile image of the particulate absorber 10 is captured at CAM/LIGHTpos2, and a second profile image of the particulate absorber 10 is captured at CAM/LIGHTpos3.

In other words, according to an example embodiment as shown in FIG. 1A, shown is a metrology platform system for particulate assessment, such as particulate measurement and counting, including one or more image capture controllers (not shown: see FIG. 4) configured to 1) position and align the light source 410 light path LIGHTPathDir and camera 310 at a first orientation CAM/LIGHTpos1 relative to the inspection surface of the particulate absorber to capture a centered top view image of the inspection surface of the particulate absorber substantially orthogonal to the inspection surface of the particulate absorber; 2) position and align the light source light path LIGHTPathDir and camera at a second orientation relative to the inspection surface of the particulate absorber to capture a first profile image of the inspection surface of the particulate absorber substantially nonorthogonal to the inspection surface of the particulate absorber; and 2) position and align the light source light path LIGHTPathDir and camera at a third orientation relative to the inspection surface of the particulate absorber to capture a second profile image of the inspection surface of the particulate absorber substantially nonorthogonal to the inspection surface of the particulate absorber.

A particulate location and size processing module (not shown: see FIG. 4) operatively associated with one or more image capture controllers (not shown: see FIG. 4), is configured to process the centered top view image of the inspection surface of the particulate absorber 10 to detect a location of each of the plurality of particulates P thereon, and the particulate location and size processing module (not shown; see FIG. 4) is configured to process one or both of the first profile image and second profile image of the inspection surface of the particulate absorber to determine a particulate size of each of the plurality of particulates P thereon; and a particulate count processing module (not shown; see FIG. 4) is configured to determine a total number of particulates P on the inspection surface of the particulate absorber 10 based on counting all located particulates P which have a particulate size greater than a threshold particulate size.

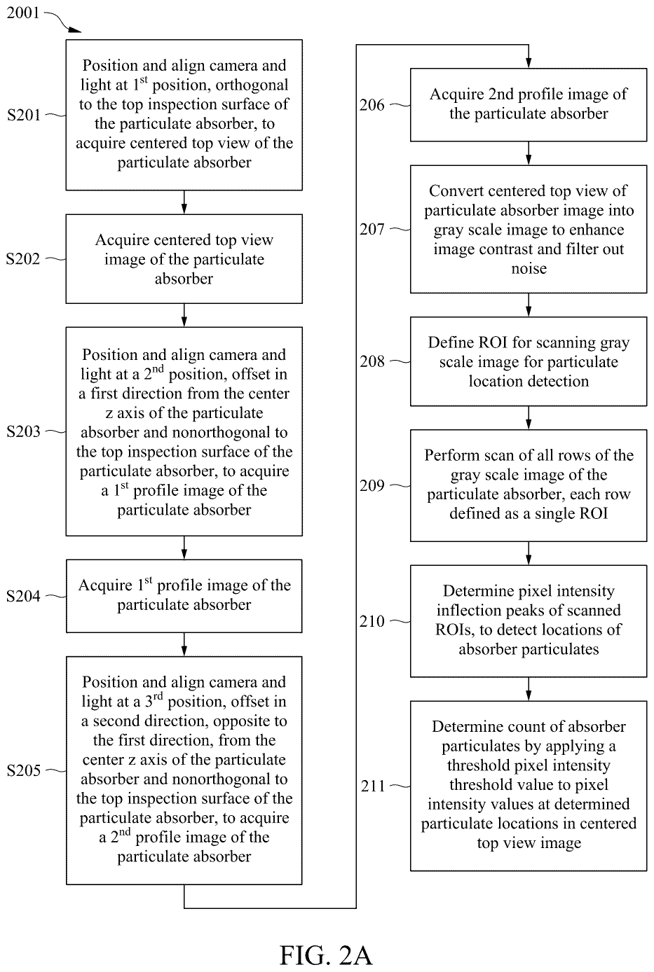

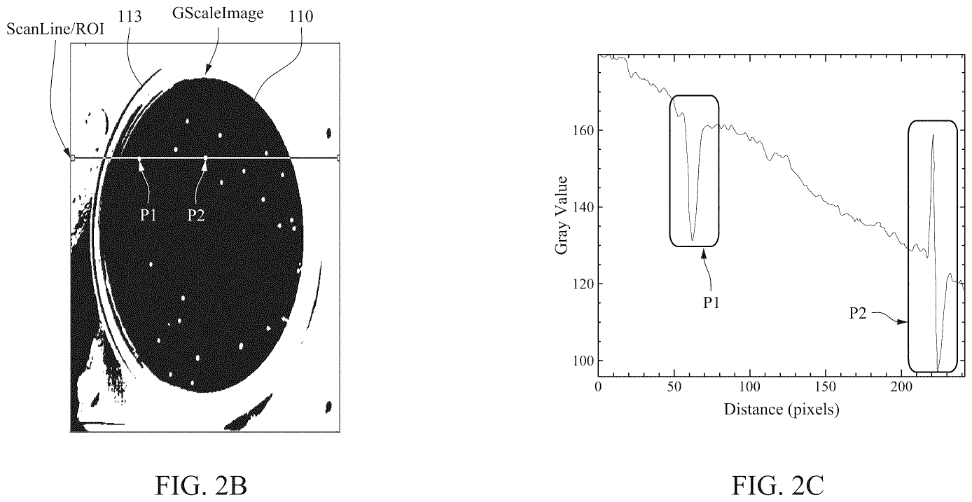

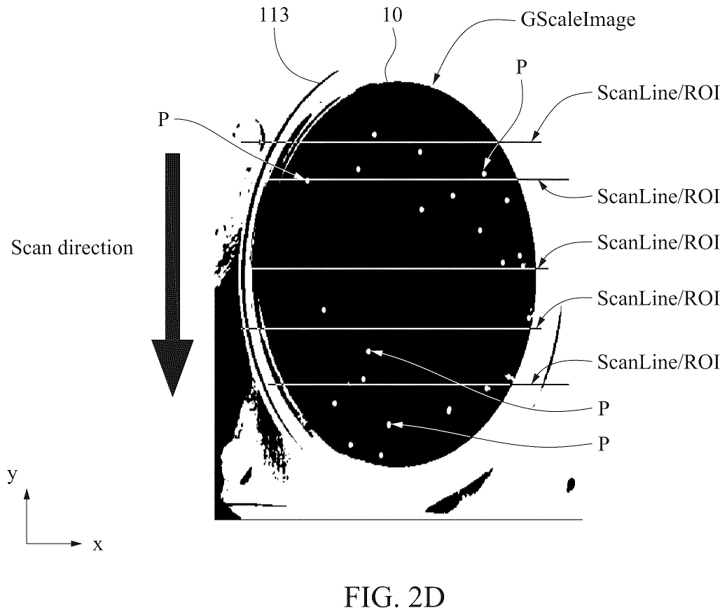

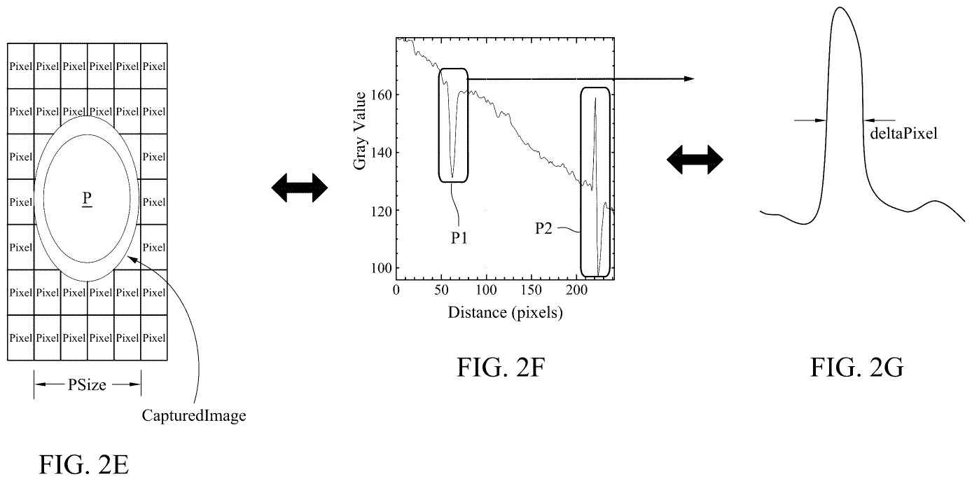

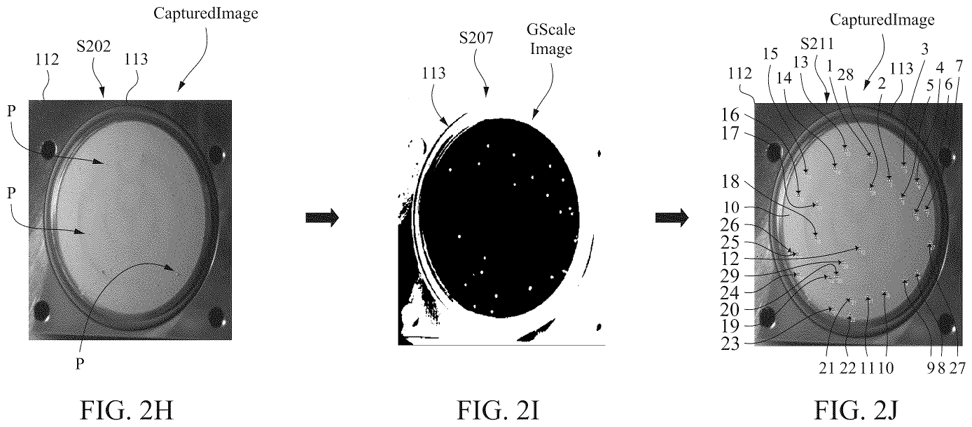

Additional features, details and other variations of the example embodiments shown in FIG. 1A, include the use of other light sources 411 (not shown: see FIG. 1C) which may be independently positioned without the use of the camera and light arm 510, the use of a coaxial light source 420 (see FIG. 1B), the use of a ring type light source 430 (see FIGS. 1B and 1C), the use of a particulate absorber holder 112 (not shown: see FIG. 2H) and O-ring 113 (not shown: see FIG. 2H) for sealing of the particulate absorber 10 from the surrounding mounting apparatus, including the absorber platform 111 and absorber holder 112, the use of a viscous glue coated on the particulate absorber surface for particulate adhesion, and the use of various light sources to enhance signals intensity (contrast) of particulates and reduce the image processing errors depending on ambient lighting conditions and/or particulate characteristics, e.g. color, shape, contours, etc.

While a single sequence of camera and light positions is described to capture images of the particulate absorber 10, to maintain consistency and accuracy of the system, subsequent sequences of captured images of the particulate absorber after removal from a device, e.g., power amplifier, are taken at substantially identical camera and light positions. Furthermore, as will described below, a machine learning process to classify captured images will provide more accurate results if the images captured of the particulate absorber 10 are captured at a predefined sequence of locations common to the use of the disclosed particulate absorber optical inspection system for all particulate absorbers inspected and used for training of the classifier.

With reference to FIGS. 1B and 1C, FIG. 1B shows a detailed view of a light source including an integrated coaxial light source 420 and a ring light source 430 according to an example embodiment of this disclosure, and FIG. 1C shows is another detailed view of a light source including an integrated coaxial light source 420 and a ring light source 430 as shown in FIG. 1B, with an additional independent other environmental light source 411 according to an example embodiment of this disclosure.

The use of a coaxial light source 420 to illuminates the particulate enhances the contrast of imaged particulates P by varying the light source wavelengths and incident angles. In addition, the type of light source-whether ring type 430 or coaxial 420 can enhance the contrast of the imaged particulates P.

With reference to FIG. 1D, shown is a schematical representation of three positions, within a xz plane, of the light and camera relative to a particulate absorber inspection surface according to an example embodiment of this disclosure, the light and camera positions including a 1^{st} position CAM/LIGHTPos1 with a field of view FOV and aligned at xzANG1, substantially equal to 90 degrees, to capture a centered top view image of the particulate absorber being inspected, a 2^{nd} position CAM/LIGHTPos2 aligned at xzANG1, within xzQuadrant1 to capture a first profile image of the particulate absorber being inspected, and a 3rd position CAM/LIGHTPos3 aligned at xzANG3 within xzQuadrant 2 to capture a second profile image of the particulate absorber being inspected.

With reference to FIG. 1E, shown is a schematical representation of three positions, within a yz plane, of the light and camera relative to a particulate absorber inspection surface according to an example embodiment of this disclosure, the light and camera positions including a 1^{st} position CAM/LIGHTPos1 aligned at yzANG1 to capture a centered top view image of the particulate absorber being inspected, a 2^{nd} position CAM/LIGHTPos2 aligned at yzANG2 within yzQuadrant1 to capture a first profile image of the particulate absorber being inspected, and a 3rd position CAM/LIGHTPos3 aligned at yzANG3 within yzQuadrant 2 to capture a second profile image of the particulate absorber being inspected.

According to some example embodiments, xzANG1 is from about 75 degrees to about 90 degrees; xzANG2 is from about 30 degrees to about 70 degrees; xzANG3 is from about 30 degrees to about 70 degrees; yzANG1 is from about 75 degrees to about 90 degrees; yzANG1 is from about 30 degrees to about 70 degrees; and yzANG1 is from about 30 degrees to about 70 degrees.

With reference to FIGS. 2A-2J, shown is a metrology platform method for particulate assessment, such as particulate measurement and counting, (Embodiment 2) 2001 including a flow chart and various processing stages of the method.

With reference to FIG. 2A, shown is a flow chart of an optical inspection method for determining a particulate count associated with a particulate absorber 10 according to an example embodiment (Embodiment 2) of this disclosure, the method including the acquisition of a centered top view image of the absorber inspection surface and one or more profile images of the absorber inspection surface, and performing a count of the absorber particulates P on the absorber inspection surface. The method, as further described below, converts captured images of the particulate absorber 10 to grayscale to filter out noise, making it easier to accurately detect and identify the position of particulates, which are then counted by setting a threshold for changes in pixel intensity.

At step 201, the method positions and aligns the camera 310 and light 410 at a 1st position, orthogonal to the top inspection surface of the particulate absorber, to acquire centered top view of the particulate absorber.

At step 202, the method acquires a centered top view image of the particulate absorber 10.

At step 203, the method positions and aligns the camera 310 and light 410 at a 2nd position, offset in a first direction from the center z axis of the particulate absorber 10 and nonorthogonal to the top inspection surface of the particulate absorber 10, to acquire a 1st profile image of the particulate absorber 10.

At step 204, the method acquires a 1st profile image of the particulate absorber 10.

At step 205, the method positions and aligns the camera 310 and light 410 at a 3rd position, offset in a second direction, opposite to the first direction, from the center z axis of the particulate absorber and nonorthogonal to the top inspection surface of the particulate absorber 10, to acquire a 2nd profile image of the particulate absorber 10.

At step 206, the method acquire 2nd profile image of the particulate absorber 10.

At step 207, the method converts the centered top view of particulate absorber 10 image into gray scale image to enhance image contrast and filter out noise.

At step 208, the method defines an ROI for scanning the gray scale image for particulate location detection.

At step 209, the method performs a scan of all rows of the gray scale image of the particulate absorber 10, each row defined as a single ROI.

At step 210, the method determines pixel intensity inflection peaks of scanned ROIs to detect locations of absorber particulates.

At step 211, the method determines a total count of absorber particulates by applying a threshold pixel intensity threshold value to pixel intensity values at determined particulate locations in the original centered top view image. According to an example embodiment, the particulate size is determined by transforming the pixel domain of the camera to an actual physical particulate size, where based on particulate measurement data a correlation of pixel size to actual physical size is observed and/or calculated.

With reference to FIGS. 2B and 2C, FIG. 2B shows a detailed view of two example particulates, P1 and P2, detected within a gray scale image GScaleImage generated according to the method of FIG. 2A, and FIG. 2C shows a detailed plot of gray value pixel intensity values vs pixel location for the example particulates, P1 and P2, shown in FIG. 2B. By varying or controlling the saturation and brightness of the captured particulate absorber images, the gray scale image conversion can be optimized based on environmental lighting conditions, camera characteristics and/or particulate properties, as well as the particular type of adhesion surface of the particulate absorber.

As shown, the ROI (region of interest) ScanLine/ROI is selected or defined, and there are two peak inflections due to changes in pixel intensity at the locations of particulates P1 and P2, which differ from the surrounding area. For reference, the o-ring 113 and the particulate absorber image 10 are labeled.

With reference to FIG. 2D, shown is another detailed view of a complete image of a captured center top view image of a particulate absorber 10, after converted to a gray scale image GScaleImage, showing a plurality of particulates P (not all Ps labeled) detected within defined scan regions of interest (ROI) in the gray scale image generated according to the method of FIG. 2A. The gray scale image GScaleImage of the particulate absorber image is scanned to cover each row of the entire image. Then the method calculates the number of peak inflections indicating the location of particulates adhered to the surface of the particulate absorber. For reference, the o-ring 113 and the particulate absorber image 10 are labeled, as well as only a portion of the particulates P.

With reference to FIGS. 2E, 2F and 2G, shown are other illustrations of the absorber particulate image processing steps to count particulates on a captured image of the absorber inspection surface shown in FIG. 2A, where FIG. 2E shows an original captured image CapturedImage of the absorber inspection surface used to measure a detected particulate size, based on the particulate's location determination from a gray scale image GScaleImage scan process to locate pixel intensity inflictions as shown in FIG. 2F, within a threshold pixel value range delatPixel, as shown in FIGS. 2F and 2G

The particulate shown in FIG. 2E has a pixel size PSize of 4 pixels, which can be calculated as having a real actual particulate size of x, e.g., x nanometers, depending on the conversions from the pixel domain of the image to actual size.

With reference to FIGS. 2H, 2I and 2J, shown is another illustration of the absorber particulate image processing steps to count particulates on a centered top view image of the particulate absorber 10 inspection surface according to the method of FIG. 2A, where FIG. 2H shows an original captured image of the absorber inspection surface, FIG. 2I shows a gray scale converted image used to detect and measure particulate locations, and FIG. 2J shows a plurality of particulates counted (1-29), based on a threshold pixel intensity value, within the original captured image at the particulate locations detected within the gray scale image GScaleImage. For reference, the o-ring 113 and the particulate absorber image 10 are labeled., as well as the particulate absorber holder 112.

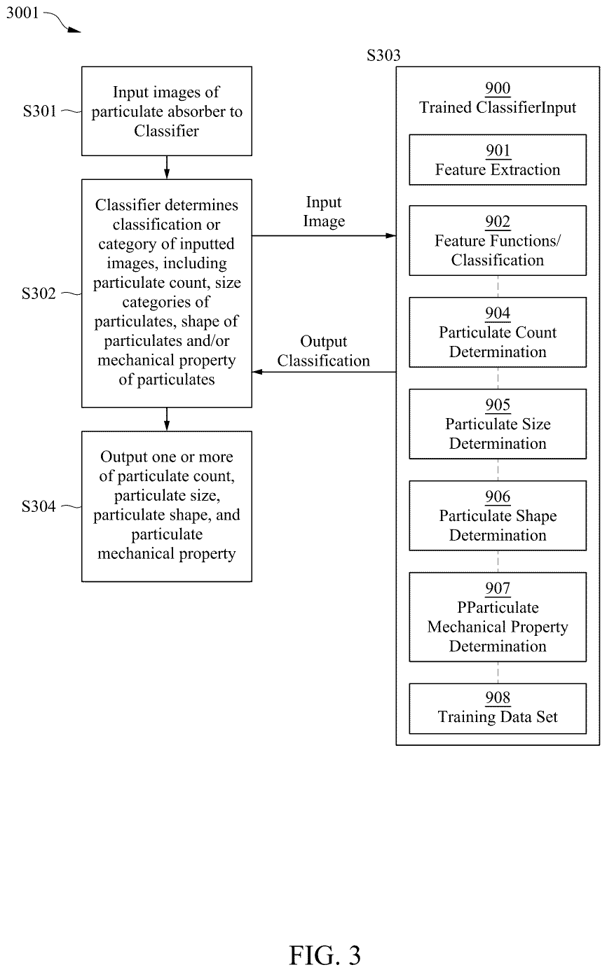

With reference to FIG. 3, shown is a flow chart of an optical inspection method (Embodiment 3) 3001 for particulate assessment, such as determining a particulate count associated with a particulate absorber 10, according to an example embodiment (Embodiment 3) of this disclosure, the method including the acquisition of a centered top view image of the particulate absorber inspection surface and one or more profile images of the absorber inspection surface. A classifier, trained using machine learning, e.g. Convolutional Neural Network (CNN), is used to perform one or more of a count of the absorber particulates on the absorber inspection surface, particulate size of the absorber particulates on the absorber inspection surface, particulate shape of the absorber particulates on the absorber inspection surface and/or mechanical property of the absorber particulates on the absorber inspection surface. In addition, the classifier can be trained to categorize input images as including particulates as being starshaped, sand shaped, or scatter shaped which can be associated with a particular particulate material or indicative of the brittleness, ductility or malleability of the particulate material.

At step 301, the method inputs images of particulate absorber 10 to the Classifier.

At step 302, the classifier determines classification or category of the input images, including particulate count, size categories of particulates, shape of particulates and/or mechanical property of particulates, using trained classifier 900, at S303, and one or more modules or executable algorithms including feature extraction module 901, feature functions/classification module 902, predictor variables module 903, particulate count determination module 904, particulate size determination module 905, particulate shape determination module 906, particulate mechanical property determination module 907, and training data set module 908.

At step 304, the method outputs one or more of particulate count, particulate size, particulate shape, and particulate mechanical property.

With reference to FIG. 4, shown is a block diagram of a metrology platform system (Embodiment 4) 4001 for particulate assessment, such as particulate size measurement and particulate counting according to an example embodiment of this disclosure.

As shown in FIG. 4, the metrology platform system includes a machine learning (ML) computer system 910 in communication with a plurality of different devices, such as metrology tools 950, which includes a particulate absorber optical inspection system 1001 having an image capture device(s). 600, particulate absorber control 240, camera device control 340, light control 440 and camera/light robotic arm control 540

The various components of the computer system 910 may be connected by a data/control bus 912. The processor of the computer system is in communication with an associated database 940 via a communications link 961. A suitable communications link 961 may include, for example, a switched telephone network, a wireless radio communications network, infrared, optical, or other suitable wired or wireless data communications. The database 940 is capable of implementation on components of the computer system 910, e.g., stored in local memory, i.e., on hard drives, virtual drives, or the like, or on remote memory accessible to the computer system.

The associated database is representative of any organized collections of data for use as a training set 900 for a ML classification system as previously discussed, including a feature extraction module 901, a feature functions module 902, a predictor variables module 903 and a training set references database module 908. Implementation of the associated database is capable of occurring on any mass storage device(s), for example, magnetic storage drives, a hard disk drive, optical storage devices, flash memory devices, or a suitable combination thereof. The associated database may be implemented as a component of the computer system, e.g., resident in memory, or the like. In one embodiment, the associated database may include data corresponding to, for example and without limitation, production scheduling, wafer positioning, process chamber information (e.g., type, position, status, etc.), optical critical dimension (OCD) information, learning algorithms, graphical user interfaces, and the like.

The feature functions 902 i.e., mathematical functions used for extracting the aforementioned features from raw data, such as, for example, and without limitation, dimension reduction functions. In some embodiments, the inverse feature functions stored in the database may correspond to mathematical formulae that may be used for reconstructing signals in feature form back into the form of raw data.

As indicated above, the associated database may further store predictor variables 903 utilized by computer system 910, as discussed in greater detail below. As will be appreciated, the predictor variables may correspond to the clues, i.e., inputs given to a model in order to determine what target variable to assign to each example. It will further be appreciated that the selected predictor variables may depend in part on the type of values used to represent them.

As shown in FIG. 4, the computer system 910 may include one or more input/output (I/O) interface devices 913 for communicating with external devices. The I/O interface 913 may communicate, via communications link 962, with one or more of a display device 920, for displaying information, such particulate counts and characteristics, pass/fail status, etc. and a user input device, such as a keyboard or touch or writable screen, for inputting text, and/or a cursor control device, such as mouse, trackball, or the like, for communicating user input information and command selections to the processor. The I/O interface 913 may communicate with external devices such as metrology tools 950, semiconductor manufacturing systems, and the like, via a suitable communications links 963. The communications links 963 may comprise any wired or wireless communications means known in the art including, for example and without limitation, 802.11(x), the public-switch telephone network, VLAN, the Internet, Bluetooth, Ethernet, cellular, or any other wired or wireless hardware, software, and/or protocols enabling electronic communication between devices.

It will be appreciated that the computer system 910 illustrated in FIG. 4 is capable of implementation using a distributed computing environment, such as a computer network, which is representative of any distributed communications system capable of enabling the exchange of data between two or more electronic devices. It will be further appreciated that such a computer network includes, for example and without limitation, a virtual local area network, a wide area network, a personal area network, a local area network, the Internet, an intranet, or any suitable combination thereof. Accordingly, such a computer network comprises physical layers and transport layers, as illustrated by various conventional data transport mechanisms, such as, for example and without limitation, Token-Ring, Ethernet, or other wireless or wire-based data communication mechanisms. Furthermore, while depicted in FIG. 4 as a networked set of components, the computer system 910 is capable of implementation on a stand-alone device adapted to interact with the metrology inspection tools 950 described herein.

The computer system 910 may include one or more of a computer server, workstation, personal computer, cellular telephone, tablet computer, pager, combination thereof, or other computing device capable of executing instructions for performing the exemplary method.

According to one example embodiment, the computer system 910 includes hardware, software, and/or any suitable combination thereof, configured to interact with an associated user, a networked device, networked storage, remote devices, or the like.

The memory 930 illustrated in FIG. 4 as a component of the computer system 910 may represent any type of non-transitory computer readable medium such as random access memory (RAM), read only memory (ROM), magnetic disk or tape, optical disk, flash memory, or holographic memory. In one embodiment, the memory 930 comprises a combination of random access memory and read only memory. In some embodiments, the processor 911 and memory may be combined in a single chip. The network interface(s) allow the computer to communicate with other devices via a computer network, and may comprise a modulator/demodulator (MODEM). Memory 930 may store data processed in the method as well as the instructions for performing the exemplary methods described herein.

The digital processor 911 can be variously embodied, such as by a single core processor, a dual core processor (or more generally by a multiple core processor), a digital processor and cooperating math coprocessor, a digital controller, or the like. The digital processor 911, in addition to controlling the operation of the computer system executes instructions stored in memory for performing the method set forth hereinafter.

As shown in FIG. 4, the instructions stored in memory 930 may include an analytical machine learning (ML) training/classifier component 800 configured to produce an analytical machine learning model for use in an optical inspection system as previously described herein. For example, modules can be included which provide instructions for executing particulate absorber optical inspection system image processing algorithms 700, particulate location determination algorithms 710, particulate size calculation algorithms 720, particulate count calculation algorithm 730, and particulate shape calculation algorithms 740. In one embodiment, the analytical machine learning model output by the analytical ML training component 800 may reveal the fitting process and signal use in the form of human readable data. The analytical ML training component 800 may utilize one or more additional components, including, for example and without limitation, an ML feature extraction component, an ML-OCD predictor component, and one or more machine learning algorithms. In accordance with one embodiment, machine learning algorithm includes, for example and without limitation, the lasso linear regression algorithm and method, however any suitable type of ML algorithm having one or more “feature selection” function would be applicable for this disclosure. (e.g.: neural network, fast Fourier Transform (FFT), principal component analysis (PCA), support vector machine (SVM), Gaussian processing, ordinary least squares regression (OLSR), linear regression, logistic regression, stepwise regression, multivariate adaptive regression splines (MARS), locally estimated scatterplot smoothing (LOESS), partial least squares regression (PLSR), or the like.

As illustrated in FIG. 4, the analytical ML training component 800 of the instructions stored in memory may also include a machine-learning feature extraction component configured to extract one or more features from the training set. According to some embodiments, the features may correspond to characteristics, properties and/or attributes extracted by statistical or machine learning functions from raw data. The extracted features may then be processed utilizing one or more feature functions, i.e., mathematical functions used for extracting the aforementioned features from raw data, such as, for example and without limitation, dimension reduction functions.

The analytical ML training component 800 of the instructions stored in memory may also utilize an ML-regressor component. In some embodiments, the ML regressor component is configured to perform regression analysis, i.e., the process of estimating the relationship between a dependent variable and independent variables. The analytical ML training component 800 may further utilize a machine learning optical critical dimension (ML-OCD) predictor component configured to generate and/or output predictor variables as inputs to the machine learning algorithm of the analytical machine learning training component (as discussed below). As will be appreciated, the predictor variables may correspond to the clues given to the model so it can decide what target variable to assign to each example. It will further be appreciated that the selected predictor variables may depend in part on the type of values used to represent them. Stated another way, the ML-OCD predictor component identifies features, characteristics, (structural parameters such as length, width, depth, etc., of structures on a wafer) to infer the CD of wafer components. Thus, after training, the ML-OCD predictor component may receive measured spectra of a wafer being analyzed in the metrology tool or in a suitably equipped semiconductor manufacturing system and predict the critical dimensionality of structures thereon, i.e., CD inference.

The various components and hardware described above with respect to FIG. 4 may be configured to perform and implement the methods previously described herein.

In the following, some further embodiments are described.

In a nonlimiting illustrative embodiment, a metrology platform system for particulate size measurement and particulate counting comprising: an absorber platform assembly, the absorber platform assembly including a platform to place a particulate absorber thereon, the particulate absorber having a plurality of particulates adhered to an inspection surface of the particulate absorber; a moveable light source aligned with the inspection surface of the particulate absorber placed on the absorber platform to illuminate the inspection surface of the particulate absorber placed on the absorber platform; a moveable camera aligned with the inspection surface of the particulate absorber placed on the absorber platform to capture images of the inspection surface of the particulate absorber placed on the absorber platform; one or more image capture controllers configured to position and align the light source and camera at a first orientation relative to the inspection surface of the particulate absorber to capture a centered top view image of the inspection surface of the particulate absorber substantially orthogonal to the inspection surface of the particulate absorber, and configured to position and align the light source and camera at a second orientation relative to the inspection surface of the particulate absorber to capture a first profile image of the inspection surface of the particulate absorber substantially nonorthogonal to the inspection surface of the particulate absorber; a particulate location and size processing module operatively associated with the one or more image capture controllers, the particulate location and size processing module configured to process the centered top view image of the inspection surface of the particulate absorber to detect a location of each of the plurality of particulates thereon, and the particulate location and size processing module configured to process the first profile image of the inspection surface of the particulate absorber to determine a particulate size of each of the plurality of particulates thereon; and a particulate count processing module configured to determine a total number of particulates on the inspection surface of the particulate absorber based on counting all located particulates which have a particulate size greater than a threshold particulate size.

In another nonlimiting illustrative embodiment, a method of determining a particulate count associated with a particulate absorber, the method comprising: placing the particulate absorber on an absorber platform assembly, the particulate absorber having a plurality of particulates adhered to an inspection surface of the particulate absorber; positioning and aligning a light source and a camera at a first orientation relative to the inspection surface of the particulate absorber, and capturing a centered top view image of the inspection surface of the particulate absorber substantially orthogonal to the inspection surface of the particulate absorber with the light source and camera oriented at the first orientation; positioning and aligning the light source and the camera at a second orientation relative to the inspection surface of the particulate absorber, and capturing a first profile image of the inspection surface of the particulate absorber substantially nonorthogonal to the inspection surface of the particulate absorber with the light source and camera oriented at the second orientation; processing the centered top view image of the inspection surface of the particulate absorber to detect a location of each of the plurality of particulates thereon, and processing the first profile image of the inspection surface of the particulate absorber to determine a particulate size of each of the plurality of particulates thereon; and determining a total number of particulates on the inspection surface of the particulate absorber based on counting all located particulates which have a particulate size greater than a threshold particulate size.

In another nonlimiting illustrative embodiment, a method of determining a particulate count associated with a particulate absorber, the method comprising: placing the particulate absorber on an absorber platform assembly, the particulate absorber having a plurality of particulates adhered to an inspection surface of the particulate absorber, and the particulate absorber defined to include a xz plane extending from the inspection surface, where the inspection surface is aligned along the x axis, and the z axis is orthogonal to the x axis and extends from a center of the particulate absorber to bifurcate the xz plane into a first quadrant and a second quadrant; positioning and aligning a light source and camera within xz plane at a first orientation relative to the inspection surface of the particulate absorber, and capturing a centered top view image of the inspection surface of the particulate absorber substantially orthogonal to the inspection surface of the particulate absorber with the light source and camera oriented at the first orientation; positioning and aligning the light source and the camera at a second orientation relative to the inspection surface of the particulate absorber and within the first quadrant of the xz plane, and capturing a first profile image of the inspection surface of the particulate absorber substantially nonorthogonal to the inspection surface of the particulate absorber and within the first quadrant of the xz plane with the light source and camera oriented at the second orientation; positioning and aligning the light source and the camera at a third orientation relative to the inspection surface of the particulate absorber and within the second quadrant of the xz plane, and capturing a second profile image of the inspection surface of the particulate absorber substantially nonorthogonal to the inspection surface of the particulate absorber with the light source and camera oriented at the third orientation and within the second quadrant of the xz plane, processing the centered top view image of the inspection surface of the particulate absorber to detect a location of each of the plurality of particulates thereon, and processing the first and second profile images of the inspection surface of the particulate absorber to determine a particulate size of each of the plurality of particulates thereon; and determining a total number of particulates on the inspection surface of the particulate absorber based on counting all located particulates which have a particulate size greater than a threshold particulate size.

In another nonlimiting illustrative embodiment, a metrology platform system for particulate assessment comprising: a particulate absorber, the particulate absorber having a plurality of particulates adhered to an inspection surface of the particulate absorber, and the particulate absorber defined to include a xz plane extending from the inspection surface, where the inspection surface is aligned along the x axis, and the z axis is orthogonal to the x axis and extends from a center of the particulate absorber to bifurcate the xz plane into a first quadrant and a second quadrant; a moveable light source aligned with the inspection surface of the particulate absorber placed on the absorber platform to illuminate the inspection surface of the particulate absorber placed on the absorber platform; a moveable camera aligned with the inspection surface of the particulate absorber placed on the absorber platform to capture images of the inspection surface of the particulate absorber placed on the absorber platform; one or more image capture controllers configured to position and align the light source and the camera at a second orientation relative to the inspection surface of the particulate absorber and within the first quadrant of the xz plane, and capturing a first profile image of the inspection surface of the particulate absorber substantially nonorthogonal to the inspection surface of the particulate absorber and within the first quadrant of the xz plane with the light source and camera oriented at the second orientation; the one or more image capture controllers positioning and aligning the light source and the camera at a third orientation relative to the inspection surface of the particulate absorber and within the second quadrant of the xz plane, and capturing a second profile image of the inspection surface of the particulate absorber substantially nonorthogonal to the inspection surface of the particulate absorber with the light source and camera oriented at the third orientation and within the second quadrant of the xz plane, a particulate location and size processing module operatively associated with the one or more image capture controllers, the particulate location and size processing module configured to process the centered top view image of the inspection surface of the particulate absorber to detect a location of each of the plurality of particulates thereon, and the particulate location and size processing module configured to process one or more of the first profile image and second profile image of the inspection surface of the particulate absorber to determine a particulate size of each of the plurality of particulates thereon; and a particulate count processing module configured to determine a total number of particulates on the inspection surface of the particulate absorber based on counting all located particulates which have a particulate size greater than a threshold particulate size.

In another nonlimiting illustrative embodiment, an optical inspection method of particulate assessment, the method comprising: placing the particulate absorber on an absorber platform assembly, the particulate absorber having a plurality of particulates adhered to an inspection surface of the particulate absorber; positioning and aligning a light source and a camera at a first orientation relative to the inspection surface of the particulate absorber, and capturing a centered top view image of the inspection surface of the particulate absorber substantially orthogonal to the inspection surface of the particulate absorber with the light source and camera oriented at the first orientation; positioning and aligning the light source and the camera at a second orientation relative to the inspection surface of the particulate absorber, and capturing a first profile image of the inspection surface of the particulate absorber substantially nonorthogonal to the inspection surface of the particulate absorber with the light source and camera oriented at the second orientation; processing the centered top view image of the inspection surface of the particulate absorber to detect a location of each of the plurality of particulates thereon, and processing the first profile image of the inspection surface of the particulate absorber to determine a particulate size of each of the plurality of particulates thereon; determining a total number of particulates on the inspection surface of the particulate absorber based on counting all located particulates which have a particulate size greater than a threshold particulate size; and using an image classifier, classifying the centered top view image and the first profile image to determine one or more of the total number of particulates on the inspection surface of the particulate absorber, the particulate size of particulates on the inspection surface of the particulate absorber and a particulate shape of particulates on the inspection surface of the particulate absorber, the image classifier trained on a plurality of training centered top view images and training profile images of a plurality of training particulate absorbers having particulates at a plurality of locations thereon, and having a plurality of sizes and a plurality of shapes thereon.

In another nonlimiting illustrative embodiment, an optical inspection method of determining a particulate count associated with a particulate absorber removed from an extreme ultraviolet (EUV) power amplifier, the method comprising: placing the particulate absorber on an absorber platform assembly, the particulate absorber having a plurality of particulates adhered to an inspection surface of the particulate absorber, and the particulate absorber defined to include a xz plane extending from the inspection surface, where the inspection surface is aligned along the x axis, and the z axis is orthogonal to the x axis and extends from a center of the particulate absorber to bifurcate the xz plane into a first quadrant and a second quadrant; positioning and aligning a light source and camera within the xz plane at a first orientation relative to the inspection surface of the particulate absorber, and capturing a centered top view image of the inspection surface of the particulate absorber substantially orthogonal to the inspection surface of the particulate absorber with the light source and camera oriented at the first orientation; positioning and aligning the light source and the camera at a second orientation relative to the inspection surface of the particulate absorber and within the first quadrant of the xz plane, and capturing a first profile image of the inspection surface of the particulate absorber substantially nonorthogonal to the inspection surface of the particulate absorber and within the first quadrant of the xz plane with the light source and camera oriented at the second orientation; positioning and aligning the light source and the camera at a third orientation relative to the inspection surface of the particulate absorber and within the second quadrant of the xz plane, and capturing a second profile image of the inspection surface of the particulate absorber substantially nonorthogonal to the inspection surface of the particulate absorber with the light source and camera oriented at the third orientation and within the second quadrant of the xz plane, processing the centered top view image of the inspection surface of the particulate absorber to detect a location of each of the plurality of particulates thereon, and processing the first and second profile images of the inspection surface of the particulate absorber to determine a particulate size of each of the plurality of particulates thereon; determining a total number of particulates on the inspection surface of the particulate absorber based on counting all located particulates which have a particulate size greater than a threshold particulate size; and using an image classifier, classifying the centered top view image, the first profile image and the second profile image to determine one or more of the total number of particulates on the inspection surface of the particulate absorber, the particulate size of particulates on the inspection surface of the particulate absorber and a particulate shape of particulates on the inspection surface of the particulate absorber, the image classifier trained on a plurality of training centered top view images and training profile images of a plurality of training particulate absorbers having particulates at a plurality of locations thereon, and having a plurality of sizes and a plurality of shapes thereon.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus 912.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A metrology platform system for particulate size measurement and particulate counting comprising:
an absorber platform assembly, the absorber platform assembly including a platform to place a particulate absorber thereon, the particulate absorber having a plurality of particulates adhered to an inspection surface of the particulate absorber;
a moveable light source aligned with the inspection surface of the particulate absorber placed on the absorber platform to illuminate the inspection surface of the particulate absorber placed on the absorber platform;
a moveable camera aligned with the inspection surface of the particulate absorber placed on the absorber platform to capture images of the inspection surface of the particulate absorber placed on the absorber platform;
one or more image capture controllers configured to position and align the light source and camera at a first orientation relative to the inspection surface of the particulate absorber to capture a centered top view image of the inspection surface of the particulate absorber substantially orthogonal to the inspection surface of the particulate absorber, and configured to position and align the light source and camera at a second orientation relative to the inspection surface of the particulate absorber to capture a first profile image of the inspection surface of the particulate absorber substantially nonorthogonal to the inspection surface of the particulate absorber;
a particulate location and size processing module operatively associated with the one or more image capture controllers, the particulate location and size processing module configured to process the centered top view image of the inspection surface of the particulate absorber to detect a location of each of the plurality of particulates thereon, and the particulate location and size processing module configured to process the first profile image of the inspection surface of the particulate absorber to determine a particulate size of each of the plurality of particulates thereon; and
a particulate count processing module configured to determine a total number of particulates on the inspection surface of the particulate absorber based on counting all located particulates which have a particulate size greater than a threshold particulate size.

2. The system of claim 1, further comprising:
a particulate shape processing module configured to determine a shape of the particulates on the inspection surface of the particulate absorber based on the first profile image.

3. The system of claim 1, wherein the light includes one or more of a coaxial light source and a ring light source.

4. The system of claim 1, wherein the moveable light source and moveable camera are attached to a single multiple axis robotic arm to align the light source and camera.

5. The system of claim 1, wherein the particulate location and size processing module converts the centered top view image to a gray scale image, scans a plurality of regions of interest (ROI) associated with a plurality of rows of the gray scale image of the captured centered top view image, and determines locations of peak intensity inflections to detect the locations of each of the plurality of particulates.

6. The system of claim 5, wherein the particulate location and size processing module uses the particulate locations detected based on peak inflections to further process the first profile image to determine the particulate size of each of the plurality of particulates based on a pixel intensity at each of the particulate locations.

7. The system of claim 1, further comprising:
an image classifier module trained on a plurality of training centered top view images and training profile images of a plurality of training particulate absorbers having particulates at a plurality of locations thereon, and having a plurality of sizes and a plurality of shapes thereon, the image classifier module configured to classify the centered top view image and first profile image to determine one or more of the total number of particulates on the inspection surface of the particulate absorber, the particulate size of particulates on the inspection surface of the particulate absorber and a particulate shape of particulates on the inspection surface of the particulate absorber.

8. The system of claim 1, wherein,
the one or more image capture controllers are configured to position and align the light source and camera at a third orientation relative to the inspection surface of the particulate absorber to capture a second profile image of the inspection surface of the particulate absorber substantially nonorthogonal to the inspection surface of the particulate absorber; and
the particulate location and size processing module is configured process the first and second profile images of the inspection surface of the particulate absorber to determine the particulate size of each of the plurality of particulates thereon.

9. The system of claim 8, wherein the particulate absorber is associated with collecting particulates within a power amplifier of an extreme ultraviolet (EUV) semiconductor fabrication lithography system during a cleaning operation, and the particulate absorber is removed from the power amplifier of the EUV semiconductor fabrication lithography system after the cleaning cycle and placed on the absorber platform assembly.

10. A method of determining a particulate count associated with a particulate absorber, the method comprising:
placing the particulate absorber on an absorber platform assembly, the particulate absorber having a plurality of particulates adhered to an inspection surface of the particulate absorber;
positioning and aligning a light source and a camera at a first orientation relative to the inspection surface of the particulate absorber, and capturing a centered top view image of the inspection surface of the particulate absorber substantially orthogonal to the inspection surface of the particulate absorber with the light source and camera oriented at the first orientation;
positioning and aligning the light source and the camera at a second orientation relative to the inspection surface of the particulate absorber, and capturing a first profile image of the inspection surface of the particulate absorber substantially nonorthogonal to the inspection surface of the particulate absorber with the light source and camera oriented at the second orientation;
processing the centered top view image of the inspection surface of the particulate absorber to detect a location of each of the plurality of particulates thereon, and processing the first profile image of the inspection surface of the particulate absorber to determine a particulate size of each of the plurality of particulates thereon; and
determining a total number of particulates on the inspection surface of the particulate absorber based on counting all located particulates which have a particulate size greater than a threshold particulate size.

11. The method of claim 10, further comprising:
determining a shape of the particulates on the inspection surface of the particulate absorber based on the first profile image.

12. The method of claim 10, wherein positioning and aligning the light source includes positioning and aligning one or more of a coaxial light source and a ring light source, and the moveable light source and moveable camera are attached to a single multiple axis robotic arm to align the light source and camera.

13. The method of claim 10, further comprising:
converting the centered top view image to a gray scale image, scanning a plurality of regions of interest (ROI) associated with a plurality of rows of the gray scale image of the captured centered top view image, and determining locations of peak intensity inflections to detect the locations of each of the plurality of particulates.

14. The method of claim 13, further comprising:
using the particulate locations detected based on peak inflections to further process the first profile image to determine the particulate size of each of the plurality of particulates based on a pixel intensity at each of the particulate locations.

15. The method of claim 10, further comprising:
using an image classifier, classifying the centered top view image and the first profile image to determine one or more of the total number of particulates on the inspection surface of the particulate absorber, the particulate size of particulates on the inspection surface of the particulate absorber and a particulate shape of particulates on the inspection surface of the particulate absorber, the image classifier trained on a plurality of training centered top view images and training profile images of a plurality of training particulate absorbers having particulates at a plurality of locations thereon, and having a plurality of sizes and a plurality of shapes thereon.

16. The method of claim 10, further comprising:
positioning and aligning the light source and camera at a third orientation relative to the inspection surface of the particulate absorber to capture a second profile image of the inspection surface of the particulate absorber substantially nonorthogonal to the inspection surface of the particulate absorber; and
processing the first and second profile images of the inspection surface of the particulate absorber to determine the particulate size of each of the plurality of particulates thereon.

17. A method of determining a particulate count associated with a particulate absorber, the method comprising:
placing the particulate absorber on an absorber platform assembly, the particulate absorber having a plurality of particulates adhered to an inspection surface of the particulate absorber, and the particulate absorber defined to include a xz plane extending from the inspection surface, where the inspection surface is aligned along the x axis, and the z axis is orthogonal to the x axis and extends from a center of the particulate absorber to bifurcate the xz plane into a first quadrant and a second quadrant;
positioning and aligning a light source and camera within the xz plane at a first orientation relative to the inspection surface of the particulate absorber, and capturing a centered top view image of the inspection surface of the particulate absorber substantially orthogonal to the inspection surface of the particulate absorber with the light source and camera oriented at the first orientation;
positioning and aligning the light source and the camera at a second orientation relative to the inspection surface of the particulate absorber and within the first quadrant of the xz plane, and capturing a first profile image of the inspection surface of the particulate absorber substantially nonorthogonal to the inspection surface of the particulate absorber and within the first quadrant of the xz plane with the light source and camera oriented at the second orientation;
positioning and aligning the light source and the camera at a third orientation relative to the inspection surface of the particulate absorber and within the second quadrant of the xz plane, and capturing a second profile image of the inspection surface of the particulate absorber substantially nonorthogonal to the inspection surface of the particulate absorber with the light source and camera oriented at the third orientation and within the second quadrant of the xz plane;
processing the centered top view image of the inspection surface of the particulate absorber to detect a location of each of the plurality of particulates thereon, and processing the first and second profile images of the inspection surface of the particulate absorber to determine a particulate size of each of the plurality of particulates thereon; and
determining a total number of particulates on the inspection surface of the particulate absorber based on counting all located particulates which have a particulate size greater than a threshold particulate size.

18. The method of claim 17, converting the centered top view image to a gray scale image, scanning a plurality of regions of interest (ROI) associated with a plurality of rows of the gray scale image of the captured centered top view image, and determining locations of peak intensity inflections to detect the locations of each of the plurality of particulates.

19. The method of claim 18, further comprising:
using the particulate locations detected based on peak inflections to further process the first profile image and second profile image to determine the particulate size of each of the plurality of particulates based on a pixel intensity at each of the particulate locations.

20. The method of claim 19, further comprising:
using an image classifier, classifying the centered top view image, the first profile image and the second profile image to determine one or more of the total number of particulates on the inspection surface of the particulate absorber, the particulate size of particulates on the inspection surface of the particulate absorber and a particulate shape of particulates on the inspection surface of the particulate absorber, the image classifier trained on a plurality of training centered top view images and training profile images of a plurality of training particulate absorbers having particulates at a plurality of locations thereon, and having a plurality of sizes and a plurality of shapes thereon.
